(19) United States
(12) Patent Application Publication
(10) Pub. No.: US 2008/0247343 A1
(43) Pub. Date: Oct. 9, 2008

(54) Method for Requesting Information

(76) Inventor: Stephan Lietz, Bad Salzdetfurth (DE)

Correspondence Address: KENYON & KENYON LLP, ONE BROADWAY, NEW YORK, NY, 10004, US

(21) Appl. No.: 11/662,303

(22) PCT Filed: Aug. 3, 2005
(86) PCT No.: PCT/EP2005/053809

§ 371 Date: Jan. 11, 2008

(30) Foreign Application Priority Data
Sep. 18, 2004 (DE) 10 2004 045 385.3

(51) Int. Cl. H04B 7/00

(52) U.S. Cl. 370/310

(57) ABSTRACT

A method for requesting information about at least one object via a network having multiple links, this at least one object is situated amidst multiple objects and each of these objects has at least one module for the exchange of data, one of the links being established in each case between two modules of two adjacent objects, thereby implementing the network.

### FIELD OF THE INVENTION

The present invention relates to a method for requesting information, an object having a number of modules, a computer program, and a computer program product.

### BACKGROUND INFORMATION

There is the need in the area of freight transportation to locate individual containers or trailers and to be able to read out information regarding their contents. It is currently customary to identify transport containers of this type using bar codes, RFID tags, radio network adapters, written records, and the like.

However, it is not possible to locate a container when it is situated amidst a block built of containers, as on a cargo ship, for example. The reason for this is the shielding effect of the typically metallic containers vis-à-vis electromagnetic waves or the inaccessibility of the container when other containers are situated around it.

### SUMMARY OF THE INVENTION

The method according to the present invention is used for requesting information about at least one object via a network having multiple links, the at least one object being located amidst multiple objects and each of these objects having at least one module for the exchange of data, one of the links being established in each case between two modules of two adjacent objects, thereby implementing the network.

Using the method, a self-organizing network, adapted to the arrangement of the objects, may be implemented as a function of the spatial arrangement of the objects, for example. Information about the at least one object may be requested in a simple manner.

In an embodiment of the present invention, a position of the at least one object designed as a container or a trailer is made available as the information. Using the present invention, it is therefore possible to overcome the known difficulties and thus to identify transport containers, to determine their positions relative to other surrounding transport containers, and to read out and/or modify information which is located in an electronic data memory of the transport container or on the transport container.

For executing the method according to the present invention it is conceivable that wireless links are established between the modules, e.g., via electromagnetic waves; light or alternatively ultrasound waves may be used as the transmission medium.

As an alternative, one link may be established between two adjacent modules of two adjacent objects and other modules may be shielded from this link if at least one of the two objects has multiple such modules. If two modules of two adjacent objects are adjoining one another it may mean that these two modules are facing one another or directly abut one another.

According to the present invention, each of the objects may be considered as a network node of the self-organizing network, for example, one or multiple links to other objects or network nodes being established via the at least one module. In this case, each object or network node has to establish links only to one or multiple neighbors.

If information about the at least one object or the at least one network node should be requested from the outside, e.g., starting from a user terminal, direct contact to the user terminal is now no longer necessary since data for the information is transmitted between the at least one object and the user terminal via the network. Data is conveyed from network node to network node or between modules of individual objects until the data reaches a recipient, in this case the user terminal.

The present invention makes it possible to communicate with individual objects or network nodes without any direct contact. It is also possible to determine the position of the object or the network node using a map of a network topology.

An application is not limited to networks alone whose exchange of data is based on the propagation of electromagnetic waves. Other active physical principles for data transmission such as light, sound, ultrasound, and the like may likewise be used along the links.

The system according to the present invention includes a number of modules; at least one of these modules is to be assigned to one object among multiple objects and each of these modules is designed for the exchange of data. Information about at least one of the objects is requested via a network having multiple links. One of the links and thus the network is established between two modules of two adjacent objects.

Using the system makes communication via the network possible between the objects which may be situated in any way one below the other or side by side.

The computer program according to the present invention having program code means is provided for the execution of all steps of the method according to the present invention when this computer program is run on a computer or an appropriate processor, in particular on the system according to the present invention.

The computer program product having program code means, which are stored on a computer-readable data medium, is provided for the execution of the method according to the present invention when this computer program is run on a computer or an appropriate processor, in particular on the system according to the present invention.

Additional advantages and embodiments of the present invention arise from the description and the attached drawing.

It is understood that the above-mentioned and subsequently to be explained features are usable not only in the particular cited combination, but also in other combinations or by themselves without leaving the scope of the present invention.

### BRIEF DESCRIPTION OF THE DRAWINGS

The present invention is schematically represented in the drawing based on exemplary embodiments and is explained in greater detail in the following with reference to the drawing.

FIG. 1 shows a schematic representation of an embodiment of a network in a first state;

FIG. 2 shows a schematic representation of the network of FIG. 1 in a second state;

FIG. 3 shows a schematic representation of an embodiment of a transport container.

### DETAILED DESCRIPTION

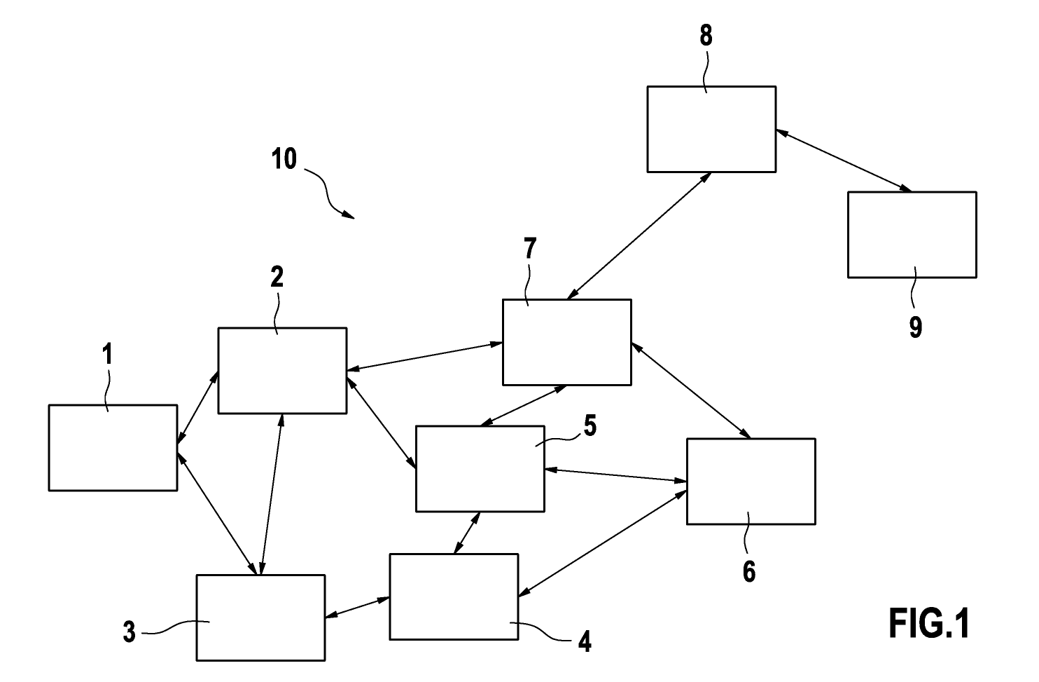

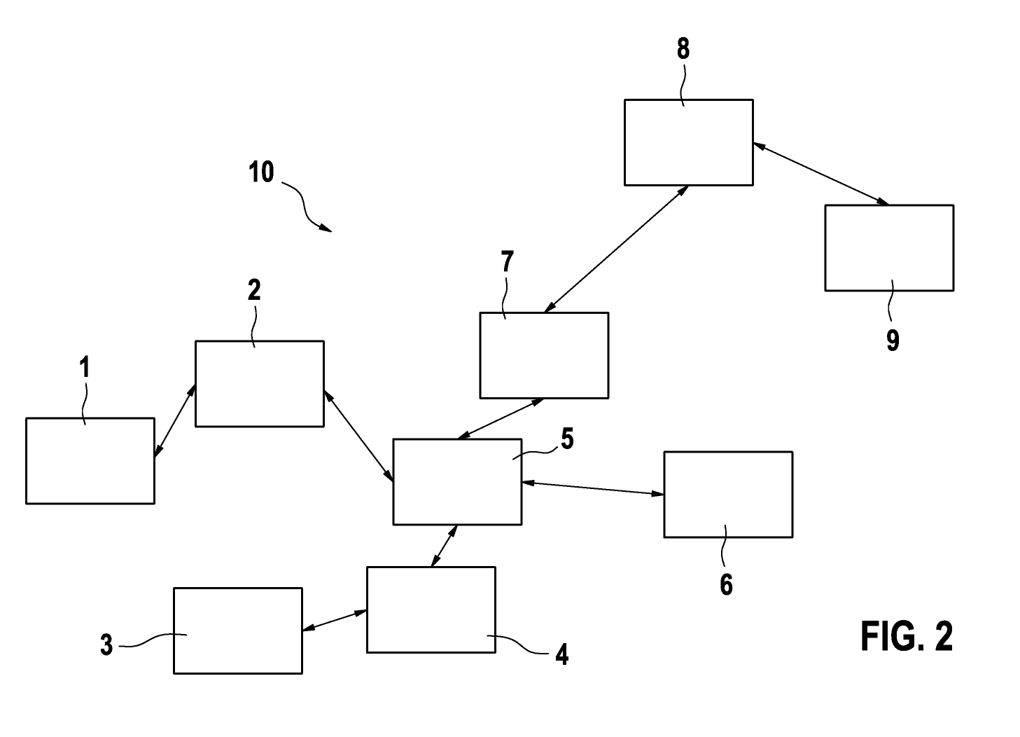

FIGS. 1 and 2 show an embodiment of network 10 in two different states which has nine network nodes or objects 1, 2, 3, 4, 5, 6, 7, 8, 9 arranged spatially relative to one another. The objects or network nodes 1, 2, 3, 4, 5, 6, 7, 8, 9 are connected to one another via links which are represented by double arrows.

FIG. 1 shows network 10 prior to a self-organization. In this state, network 10 is highly interconnected. Compared to the state represented in FIG. 2, substantially more links are established between the individual objects 1, 2, 3, 4, 5, 6, 7, 8, 9.

Network 10 assumes the state shown in FIG. 2 after the self-organization. Most of network nodes 1, 2, 3, 4, 5, 6, 7, 8, 9 now only have one or at best two links to adjacent network nodes 1, 2, 3, 4, 5, 6, 7, 8, 9. Only the fifth network node 5 has links to four adjacent network nodes 2, 4, 6, 7 because of its central position within network 10.

Network nodes 1, 2, 3, 4, 5, 6, 7, 8, 9 may directly exchange data and information with at least one adjacent network node 1, 2, 3, 4, 5, 6, 7, 8, 9 via the links, but not, however, with all network nodes 1, 2, 3, 4, 5, 6, 7, 8, 9. A link between some of network nodes 1, 2, 3, 4, 5, 6, 7, 8, 9, e.g., between first network node 1 and seventh network node 7 or between sixth network node 6 and ninth network node 9, may be impossible due to shielding or due to excessive distance.

The state of network 10 represented in FIG. 2 results after the self-organization as it is known from different types of networks such as Bluetooth, the IEEE 802.3 standard (W-LAN), or the IEEE 1394 standard. Since data and information are transmitted in each case from one network node 1, 2, 3, 4, 5, 6, 7, 8, 9 to the next, communication between all network nodes 1, 2, 3, 4, 5, 6, 7, 8, 9 is possible via network 10.

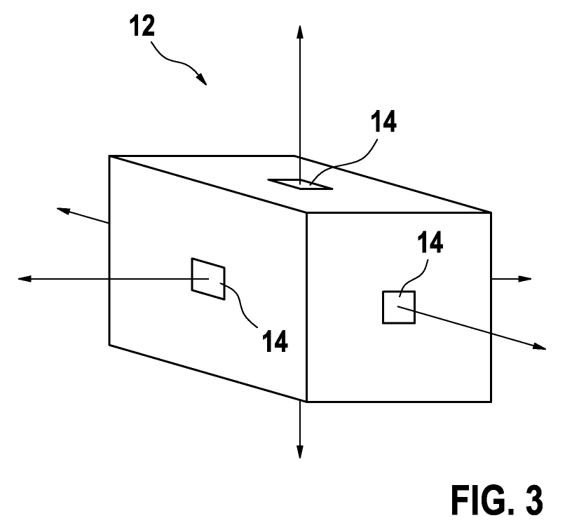

FIG. 3 shows a schematic representation of a cuboid-shaped transport container 12, e.g., a container, which has a module 14 on each of its six exterior sides. Modules 14 may be transmitters for electromagnetic waves, such as high-frequency transmitters having directional antennas, for example. The arrows represent the main beam directions of these transmitters or modules 14.

Transport container 12 may be situated in a block or a cube amidst a plurality of similar transport containers 12 which are situated directly above, adjacent, or under it. Modules 14 make it possible that links are established between two adjacent transport containers 12. In the case of a plurality of transport containers 12, a network, composed of many links, is thus established between adjacent transport containers 12 via modules 14. Exchange of data and information between transport containers 12 is possible via this network established via the links.

When modules 14 are used, which transmit in one main beam direction, unambiguous [unidirectional ?] links may be provided between adjacent transport containers 12.

It is thus possible to establish a spatial position of all transport containers 12, which are situated in a system relative to one another, via a map of a network topology. Furthermore, it is possible to request information via the network about at least one of the objects.

1-11. (canceled)

12. A method for requesting information about at least one object via a network having multiple links, comprising:
situating the at least one object amidst multiple objects and each of these objects having at last one module for an exchange of data; and
establishing one of the links in each case between two modules of two adjacent objects, thereby implementing the network.

13. The method as recited in claim 12, further comprising:
providing a position of the at least one object as the information.

14. The method as recited in claim 12, further comprising:
establishing wireless links between the modules.

15. The method as recited in claim 12, further comprising:
establishing the links between the modules via electromagnetic waves.

16. The method as recited in claim 15, wherein light is used as a transmission medium for establishing the links between the modules.

17. The method as recited in claim 12, further comprising:
establishing the links between the modules using ultrasound waves.

18. The method as recited in claim 12, further comprising:
establishing one of the links in each case between two modules of two adjacent objects; and
shielding other modules are shielded from the established link.

19. The method as recited in claim 12, wherein the objects include containers.

20. A system, comprising:
a plurality of modules, at least one of the modules being assigned to an
